(19) United States
(12) Patent Application Publication
(10) Pub. No.: US 2008/0211151 A1
(43) Pub. Date: Sep. 4, 2008

(54) Vibration Damper, in Particular for Applying to a Motor Vehicle Seat

(76) Inventors: Wolfgang Wieser, Kraiburg (DE); Wolfgang Orthofer, Ampfing (DE); Franz Kobus, Jettenbach (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/912,511

(22) PCT Filed: Mar. 15, 2006
(86) PCT No.: PCT/EP06/02374

§ 371 Date: Oct. 25, 2007

(30) Foreign Application Priority Data
Apr. 26, 2005 (DE) 10 2005 019 323.4

(51) Int. Cl. F16F 7/108; B60N 2/68

(52) U.S. Cl. 267/136

(57) ABSTRACT

The invention relates to a vibration damper (10), in particular for attachment to a motor vehicle seat, with a carrier frame (12), a vibration mass (26) and a spring arrangement (18, 20), wherein the carrier frame (12) and the vibration mass (26) are coupled to one another via the spring arrangement (18, 20). In this vibration damper (10) it is envisaged that the spring arrangement (18, 20) comprises at least one elastic connection element (18, 20), which is formed integrally on the carrier arm (12) and on the vibration mass (26).

The present invention relates to a vibration damper, in particular for attachment to a motor vehicle seat, with a carrier frame, a vibration mass and a spring arrangement, wherein the carrier frame and the vibration mass are coupled to one another via the spring arrangement.

It is generally known that vibrations can occur in motor vehicles due to travel movements as well as external influences, such as unevennesses in the road surface or other periodic or impact-like stresses. These vibrations are transmitted from the body of the vehicle to various vehicle components and ad inter alia on the passengers in the vehicle. Such vibrations can on the one hand lead to undesirable noise inside the vehicle, and on the other hand, even without any noise stress, can adversely affect the comfort of passengers in a motor vehicle. Attempts have therefore already been made in the automobile industry in the construction of vehicles to counteract the occurrence of vibrations or to suppress these after their formation. Various approaches are employed in this respect. One possible solution to this problem consists in providing individual vehicle components with a high degree of rigidity and a high moment of inertia, in order to reduce their susceptibility to vibration. This runs counter however to the general aim of a lightweight construction, which leads to savings in weight and thereby also to a reduced fuel consumption of the vehicle. An alternative way of circumventing the solid construction design is to greatly dampen vibrations occurring in lightweight components. For this purpose vibration dampers are used in vehicle construction technology. These vibration dampers are attached to components of the vehicle susceptible to vibration and are excited by the vibrating vehicle components to execute an intrinsic vibration. The intrinsic vibration occurs as a rule in opposite phase to the undesired vibration of the vehicle component, which ultimately leads to a reduction in the vibration. One also speaks of a vibration damping.

It has been shown that such vibrations also occur in motor vehicle seats and have to be suppressed. In recent times entertainment systems, such as for example flat screens for a DVD or TV system, have been installed in the backrests of motor vehicle seats, especially in top of the range models, so that the rear passengers can view these screens. However, it is necessary particularly with such types of vehicle to suppress vibrations of the seat rest caused by vibrations occurring in the vehicle, in order on the one hand to reduce the mechanical stresses acting on the screen so as to increase the service life of the latter, and on the other hand to increase the viewing comfort by avoiding a “shaking movement”.

Vibration dampers that can be integrated in motor vehicle seats are already known from the prior art. Thus, for example, the document DE 103 27 711 A1 shows a vibration damper of the type identified in the introduction which can be arranged in a motor vehicle seat. This vibration damper is provided with a frame structure, which can be coupled via a hoop arrangement to a leaning frame of the vehicle seat. Within the frame structure a vibration mass is arranged, which is connected via a spring arrangement to the said frame structure. The vibration mass is of elongated shape and is provided at its ends with a recess. The recess accommodates spring elements of complicated shape. The spring elements are made of elastomeric material and at one end are vulcanised into plastic rings, and at the other end are connected by vulcanisation to a securement bolt. The plastics rings are then pressed into the recess of the vibration mass. The end of the spring elements provided with the bolt is then inserted into the carrier structure of the vibration damper. On account of the relatively complicated structure of this vibration damper, a large number of installation steps are required in order finally to prepare this for attachment to a leaning frame. Moreover, this vibration damper suffers from the problem of a high susceptibility to failure, since on account of the large number of mechanical connections, for example the connection between the vibration mass and frame structure to be effected during the installation, there is a relatively high probability that two components will become dislocated relative to one another on account of the occurring vibrations, and therefore the functioning of the vibration damper will be impaired or basically disturbed.

A similar vibration damper is known from the document DE 103 27 770 A1. This vibration damper too suffers from the problem that it consists of a large number of parts, which require a relatively complicated and therefore cost-intensive installation and furthermore increase the susceptibility to failure.

As regards further prior art reference is made to the document DE 199 08 916 A1.

The object of the present invention is to provide a vibration damper of the type identified in the introduction, which being easier and cheaper to produce offers a high degree of reliability and long service life combined with a good vibration damping capability.

This object is achieved by a vibration damper of the type identified in the introduction, in which the spring arrangement comprises at least one elastic connection element that is formed integrally on the carrier frame and on the vibration mass. Instead of a multi-part design and construction of the vibration damper and subsequent installation, the invention envisages that, although the vibration damper is produced from the three individual components carrier frame, vibration mass and spring arrangement, nevertheless these three individual components are combined with one another in a quasi-integral manner, so that in the subsequent installation, for example on a leaning frame of a motor vehicle seat, the vibration damper can be installed as a structural part, and that also in the subsequent operation, on account of the integral design of the vibration damper no undesired displacement of individual components on account of the acting mechanical stresses can occur. Due to the integral design of the vibration damper the installation effort can be substantially reduced compared to the prior art and the reliability can be significantly increased.

In a modification of the invention it is envisaged that the elastic connection element is produced from an elastomeric material, preferably from natural rubber, and is in each case vulcanised on the carrier frame and on the vibration mass. It is understood that the connection element can also be produced from an elastomeric material other than natural rubber. Due to the vulcanising of the connection elements on the carrier frame and vibration mass, the vibration damper has the advantageous configuration of an integral structural part, which despite the mechanical stresses that occur during operation, in particular vibrational stresses, does not undesirably deform. In addition the vibration damper is considerably easier to produce. The carrier frame and the vibration mass are in this connection placed in a pre-fabricated mould, and the elastomeric material is then injected into the mould by an injection method and vulcanised onto the carrier frame and the vibration mass. The elastic connection elements of the spring arrangement are also formed at the same time.

In an advantageous embodiment of the invention it is envisaged that the elastic connection element includes a substantially semi-cylindrical strut member. The design as a semi-cylindrical strut member has the advantage that the connection elements have substantially the same vibration behaviour in all vibration directions which run in a plane orthogonal to the cylindrical longitudinal axis. However, the individual connection elements may also have different geometries, for example so as to promote vibrations in specific directions, and on the other hand suppress vibrations in other directions.

In an example of implementation of the invention it is envisaged that the vibration mass is connected via at least two elastic connection elements to the carrier element. In this connection it may advantageously be envisaged that the connection elements are arranged on mutually opposite sides. Alternatively, more than two elastic connection elements may also be provided.

It has been found that in particular vibrations with very low frequencies are difficult to damp. The vibration damper according to the invention was designed specifically for this particular case. Thus, for the vibration damper according to the invention it is envisaged that it has an intrinsic frequency in the range from 6 to 18 Hz, preferably from about 9 to 14 Hz. Moreover, for the vibration dampers according to the invention it is advantageous if the vibration mass produces a vibration mass amplitude of 0 to 5 mm at an excitation amplitude of greater than or equal to 0.2 mm.

In an advantageous embodiment of the invention it is envisaged that the carrier frame is of C-arcuate design. This has the advantage that the carrier element can be of lightweight construction. However, it is also obvious that more solid carrier elements with a closed profile can be used. In a modification of the C-arcuate shaped carrier element it is envisaged that the carrier frame in the region of its free ends is coupled in each case via at least one connection element to the vibration mass. A particularly inexpensive but nevertheless sufficiently stable configuration of the carrier element is then provided for example if the carrier frame and/or the vibration mass are produced from a sheet metal material.

In order to increase the reliability of the vulcanised connection between the carrier elements, a modification of the invention envisages that the carrier element is pre-treated so as to facilitate an integral forming of the connection elements by vulcanisation.

It may furthermore be envisaged according to the invention for the vibration mass to include a metal body, preferably of a cast material. This has the advantage that the vibration mass can be arbitrarily designed as regards its geometry and can be adapted to the respective specific case.

An advantageous modification of the invention envisages that the metal body is provided, at least over certain regions, with a coating, preferably of elastomeric material. Advantageously it is envisaged that the coating is produced when the connection elements are vulcanised on. As has already been mentioned hereinbefore, the vibration damper according to the invention can be produced by placing the carrier frame and the vibration mass in a mould, into which the elastomeric material is then injected by an injection process. Advantageously in this connection the mould is configured so that during the injection of the elastomeric material a skin of elastomeric material, for example of about 1 mm wall thickness, is formed around the metal body of the vibration mass. This has the result that the metal body of the vibration mass is surrounded by a damping coating, so that in the event of an extreme deflection of the vibration mass, in which this comes into contact with surrounding structural parts, for example with the carrier frame, the impact is damped and no loud impact noise can be produced.

The invention is described by way of example hereinafter with the aid of the accompanying drawings, in which:

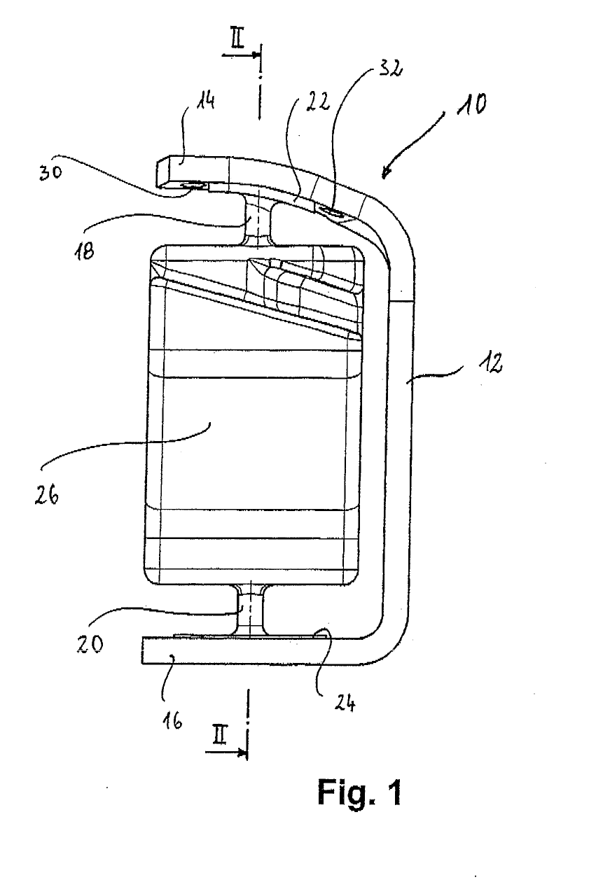

FIG. 1 is a front view of the vibration damper according to the invention;

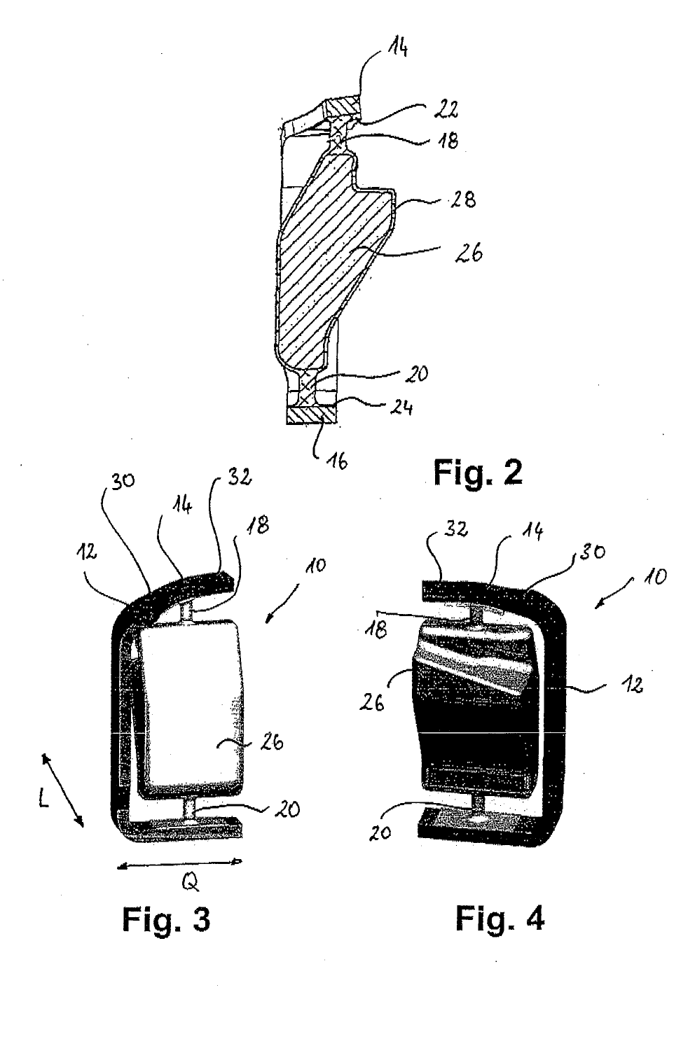

FIG. 2 is a sectional view along the sectional line II-II of FIG. 1;

FIG. 3 is a perspective rear view of the vibration damper according to the invention;

FIG. 4 is a perspective front view of the vibration damper of FIG. 1 according to the invention, and

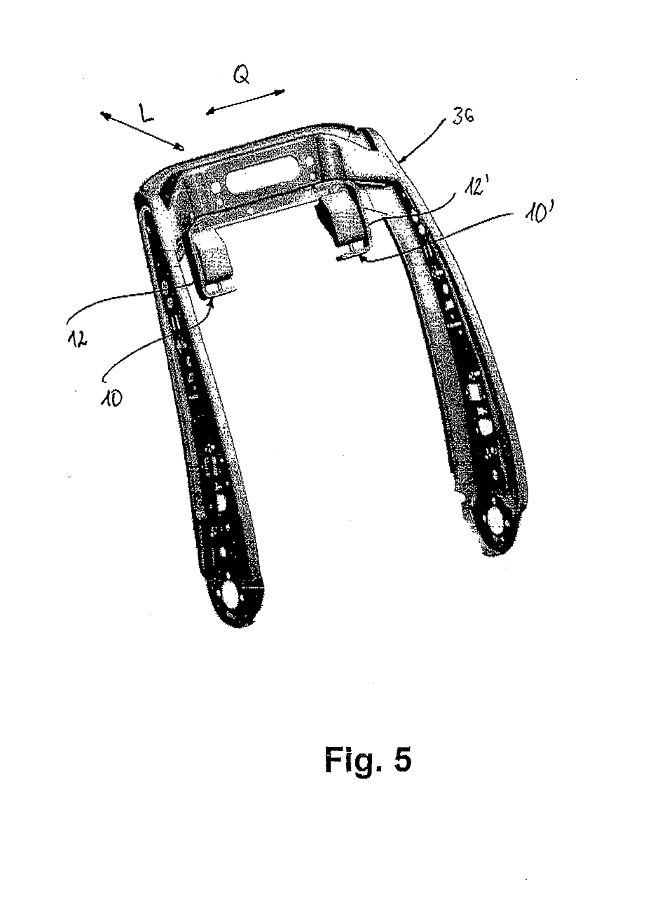

FIG. 5 shows the situation in which two vibration dampers according to the invention are attached to a leaning frame of a motor vehicle seat.

FIG. 1 shows a front view of a vibration damper according to the invention, generally identified by the reference numeral 10. The vibration damper according to the invention includes a carrier frame 12, which is produced from a C-shaped sheet metal material. In the region of its free ends 14 and 16 connection elements 18 and 20 of elastomeric material are vulcanised on the carrier frame 12. Relatively large two-dimensional elastomeric sections 22 and 24 can be recognised on the inside surfaces of the carrier frame 12. The connection elements 18 and 20 are of substantially semi-cylindrical shape and transform smoothly, with the avoidance of sharp edges, into the elastomeric sections 22 and 24. A vibration mass 26 is formed on the inner ends of the connection elements 18 and 20. Reference is made here in particular to the sectional representation according to FIG. 2. The vibration mass 26 is a body of grey cast iron, which is enclosed substantially completely by an elastomeric skin 28. The elastomeric skin 28 transforms smoothly into the connection elements 18 and 20 and is likewise vulcanised onto the vibration mass 26. All transitions, in particular from the elastomeric skin 28 to the connection elements 18 and 20, are harmonically configured. The geometry of the vibration mass 26 is adapted to the respective installation situation in the motor vehicle seat.

FIGS. 3 and 4 show various perspective views of the vibration damper 10 according to the invention. It can be seen in FIGS. 3 and 4 that in each case recesses 30 and 32 are provided on the upper free end 14 of the carrier frame 12, which recesses permit a securement of the vibration damper to a leaning frame. Such an installation situation can be recognised for example in FIG. 5, in which vibration dampers 10 and 10′ configured laterally displaced with respect to one another are secured to a leaning frame 36 for a backrest of a motor vehicle seat. It can also be seen that the geometry of the vibration mass 26 is adapted to the actual installation situation. The securement of the two carrier frames 12 and 12′ is effected by means of appropriate bolts engaging in the recesses 30 and 32 illustrated in FIGS. 1, 3 and 4.

In operation vibrations occur on the leaning frame 36, especially in the transverse direction Q and also in the longitudinal direction L. Such vibrations have in particular relatively low frequencies, for example in the region of less than 20 Hz, and excitation amplitudes in the range from 0.2 mm to 1 mm. These vibrations are transmitted via the carrier frame 12 and the connection elements 18 and 20 to the vibration mass 26. The vibration mass 26 is thereby excited to perform a vibrational movement of opposite phase, and specifically in the longitudinal direction as well as in the transverse direction, whereby the elastic connection elements 18 and 20 yield elastically. They are thereby subjected to a parallel axial load. Due to the counter-phase vibration movement of the vibration mass 26, the vibrations acting on the leaning frame 36 are damped. The intrinsic vibration frequency of the vehicle seat is thus damped and the seat therefore vibrates much less intensively. In addition the components connected to the seat rest, for example the screen of a vehicle entertainment system, are subjected to less powerful vibration stresses. Their service life can thereby be significantly increased. Moreover, there is no annoying shaking movement of the screen when viewing the entertainment program.

The essential advantages of the vibration damper 10 according to the invention are the fact that the damper has very low intrinsic frequencies, for example in the range from 6 to 18 Hz, preferably in the range from 9 to 14 Hz. In addition the vibration mass 26 of the vibration damper 10 according to the invention can handle relatively large amplitudes during the vibration movement, for example in the range from 0 to 5 mm, which leads to a particularly effective vibration damping. A further advantage of the solution according to the invention is that, due to the rubber coating of the vibration mass 26, no undesired noise can occur under extreme vibration movements, in which the vibration mass 26 strikes the carrier frame 12 for example. Overall the invention provides a vibration damper that can be produced more easily, combined with a high vibration damping efficiency and long service life.

1. Vibration damper (10), in particular for attachment to a motor seat, comprising:
a carrier frame (12),
a vibration mass (26) and
a spring attachment (18, 20),
wherein the carrier frame (12) and the vibration mass (26) are coupled to one another via the spring arrangement (18, 20), characterised in that the spring arrangement comprises at least one elastic connection element (18, 20), which is integrally formed on the carrier frame (12) and on the vibration mass (26), that the carrier frame (12) is of C-arcuate shape, wherein the carrier frame (12) is coupled in the region of its free ends (14, 16) in each case via at least one connection element (18, 20) to the vibration mass (26), and that the vibration damper has an intrinsic frequency in the range from 6 to 18 Hz, preferably from about 9 to 14 Hz.

2. Vibration damper (10) according to claim 1, characterised in that the elastic element (18, 20) is produced from an elastomeric material, preferably from natural rubber, and is vulcanized in each case on the carrier frame (12) and on the vibration mass (26).

3. Vibration damper (10) according to claim 1, characterised in that the elastic connection element (18, 20) includes a substantially semi-cylindrical strut member.

4. Vibration damper (10) according to claim 1, characterised in that vibration mass (26) is connected via at least two elastic connection elements (18, 20) to the carrier element (12).

5. Vibration damper (10) according to claim 4, characterised in that the connection elements (18, 20) are arranged on mutually opposite sides of the vibration mass (26).

6. Vibration damper (10) according to claim 1, characterised in that the vibration mass (26) at an excitation amplitude of greater than or equal to 0.2 mm ensures a vibration mass amplitude of 0 to 5 mm.

7. Vibration damper (10) according to claim 1, characterised in that the carrier frame (12) and/or the vibration mass (26) is produced from a sheet metal material.

8. Vibration damper (10) according to claim 1, characterised in that the carrier frame (12) is pretested so as to facilitate an integral forming of the connection elements (18, 20) by vulcanization.

9. Vibration damper (10) according to claim 1, characterised in that the vibration mass (26) includes a metal body, preferably of a cast material.

10. Vibration damper (10) according to claim 9, characterised in that the metal body is provided at least in certain regions with a coating, preferably of elastomeric material (28).

11. Vibration damper (10) according to claim 10, characterised in that the coating (28) is produced when the connection elements (18, 20) are vulcanized on.
